(19) United States
(12) Patent Application Publication
(10) Pub. No.: US 2018/0264423 A1
(43) Pub. Date: Sep. 20, 2018

(54) Frame For Clamping A Container And Method For Mixing In A Flexible Container And Container For Clamping

(71) Applicant: Andocksysteme G. Untch GmbH, Badenweiler (DE)

(72) Inventor: Günter Untch, Müllheim (DE)

(73) Assignee: Andocksysteme G. Untch GmbH, Badenweiler (DE)

(21) Appl. No.: 15/802,143

(22) Filed: Nov. 2, 2017

(30) Foreign Application Priority Data
Nov. 2, 2016 (DE) 10 2016 120 898.1

(51) Int. Cl. B01F 15/00; B01F 13/04; B01F 15/02; B01F 13/00; B65D 33/16; B65D 30/08; B65D 5/00; B65D 57/00

(52) U.S. Cl. CPC B01F 15/00766; B01F 13/045; B01F 15/0085; B01F 15/00545; B01F 15/0217; A61J 1/16; B65D 33/1641; B65D 31/04; B65D 5/008; B65D 57/00; B65D 2217/00; B01F 13/0042

(57) ABSTRACT

A flexible package for storing and transporting bulk goods. Such flexible package can have material-impermeable connections for spreading out sections of the flexible package wall so as to correspond to a predefined shape. One or more docking connections for filling and discharging can be included. The flexible package can have a square bottom and adjacent to the sides thereof triangular stubs as lateral walls. Together, such lateral walls can form an upwardly open pyramid shape. Opposite the bottom, a coupling element can be connected in such a manner that it presents the flexible package so as to be sealable in a standardized manner on open-sided ends of the lateral walls.

### CROSS-REFERENCE TO RELATED APPLICATIONS

This application claims priority to German Patent Application No. 10 2016 120 898.1, filed Nov. 2, 2016, which is incorporated by reference in its entirety.

### SUMMARY

Container mixers are known which are specially designed for a mixing process that is gentle to the product, and for a flexible reception of various mixing containers, such as for example in the pharmaceutical sector. A hydraulic spreading out system ensures reception of the mixing containers. A PLC and recipe controlled mixing process allows an adaptation to the product to be mixed. The reception of different container sizes or adapters for drums and small containers can be realized using a spreading beam system. As handling functions, lifting, lowering, rotating, pivoting of a mixer column are required. Users expect such a mixing technology to provide for automatic loading and unloading. It should be possible to use a chopper in the mixing container. A spray system for applying liquids onto the mix, weighing technology provided upstream and downstream, metered discharging, an NIR system, etc., are to be employed. The requirement altogether is: reproducible mixing in a closed system.

To this end, known mixing containers are made for example from stainless steel. Mixing containers vary with regard to their basic dimensions and their height, free-standing or floor/ceiling supported versions. According to the prior art, the loading of the mixing container may be carried out by means of trolleys, pallet trucks up to fully automated roller conveyor loading and unloading. Different container clamping systems of a manual up to a fully automated version are then used for securely clamping the mixing container to the known mixing device. A safety housing is provided as a function of the installation location and the process flow. After clamping, a standard inclined orientation relative to the mixing axes should have been achieved.

In the head space of the container, no additional fittings are to be present. An integration of upstream and/or downstream processes as well as handling functions (lifting, tilting, pivoting, setting down, docking etc.) is required, as well as a highly level of availability, since the cleaning of the known mixing container is carried out outside of the mixer. Frequently, an exposure-proof version is required.

The materials to be mixed in a reproducible manner are often supplied in flexible packages which then have to be filled into two mixing containers. So far, mixing containers had to be emptied into further packages after mixing and then cleaned. It is the object of the present disclosure to simplify these processes without jeopardising reproducibility.

To this end it is proposed to allow mixing in a “single-use bag”, which should be carried out in a manner comparable with known small batch mixers as described above. The flexible package, in which the material to be mixed is supplied, should already meet certain preconditions at the entry stage. Namely, it should be possible to clamp it into a frame in such a way that at least sections of the flexible package walls adopt a predefined shape which the mixing container should assume prior to the start of the mixing process, so as to be able to mix in a reproducible manner.

A flexible package, which is for example already a storage and transport package, can be used as a mixing container, by clamping the flexible packaging into a frame for mixing, so that at least almost solid walls and bottoms are formed and a reproducible mixing process is achieved in this package that is now at least not completely flexible any longer. For this mixing process in fixed containers has been multiply validated and the process security is therefore maintained if according to the present disclosure the need to empty the flexible transport container into a mixing container is eliminated, but rather the flexible transport container itself becomes the mixing container.

Accordingly, the need of washing transport containers or mixing containers is totally eliminated, with no need for container washing machines any more etc.

To this end, the present disclosure proposes for example a frame having four identical lateral portions made from stainless steel sheet. During making up, the flexible package shaped in a preferred manner, which has four lateral pockets, is mounted in the frame from the top and is securely clamped in the bottom region. In this way, similar conditions as in the known stainless steel container as mixing container are provided for the mixing process.

A process according to the present disclosure, in particular for mixing bulk goods in a flexible package, advantageously uses a flexible package and a frame according to the present disclosure, in order to save altogether for example costs and efforts, whilst at the same time still meeting reproducibility requirements.

An advantageous embodiment of a frame for receiving the single use package has generally triangular lateral wall elements that are supported in the frame in a manner so as to be rotational about a bottom base. The upper free end of the respective lateral wall element is shaped in a congruent manner for receiving a top end of the package. Particularly preferably, the four upper free ends can be connected as a ring around a flange, which at the same time effects a “holding taut” of package walls by means of the lateral wall elements formed as clamping surfaces.

### BRIEF DESCRIPTION OF THE DRAWING

The present disclosure will be explained in more detail below with reference to an embodiment example shown in the figures, wherein:

FIG. 1 shows a perspective view of a flexible package, which is provided above a frame with opened clamping surfaces for clamping the flexible package, with the frame being shown above a movable cart,

FIG. 2 shows the frame with the movable cart from FIG. 1 having clamping surfaces closed around the flexible package,

FIG. 3A shows a lateral view onto a flexible package inserted into the frame from FIG. 1 (the obscuring frame side is hidden) with detailed views in FIG. 3B and in FIG. 3C,

FIG. 4A and FIG. 4B show a lateral view and a perspective view of a flexible package without a frame,

FIG. 5A and FIG. 5B show two lateral views, turned 90° towards each other, of a further example of a flexible package, and

FIG. 6 shows a perspective view of the flexible package from FIG. 5 at an angle from the bottom with a seam course in the bottom.

### DETAILED DESCRIPTION

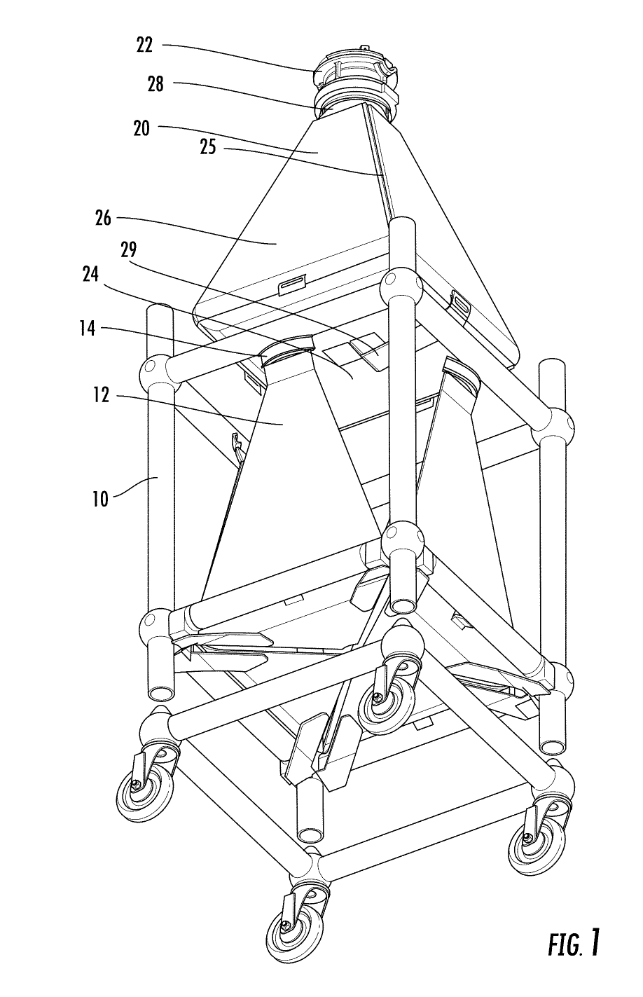

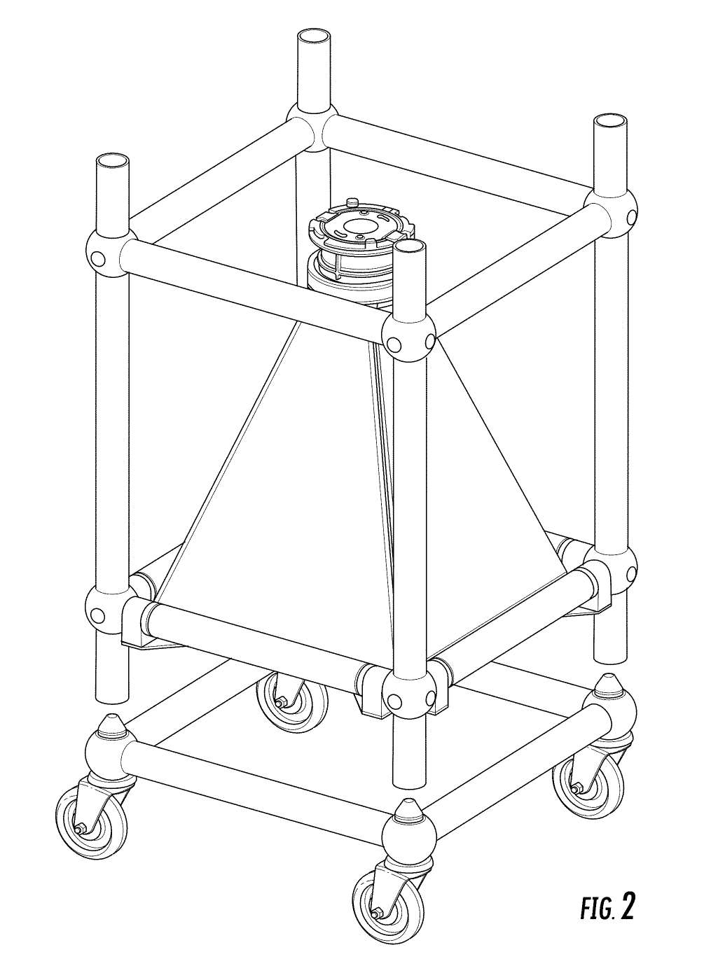

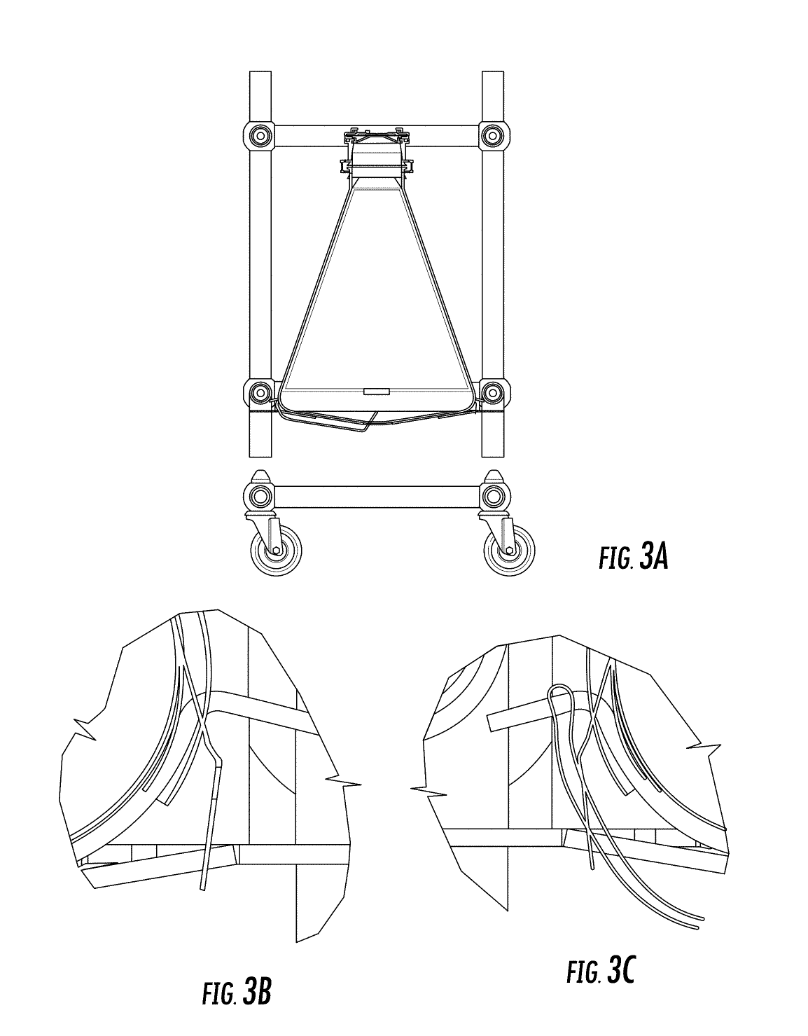

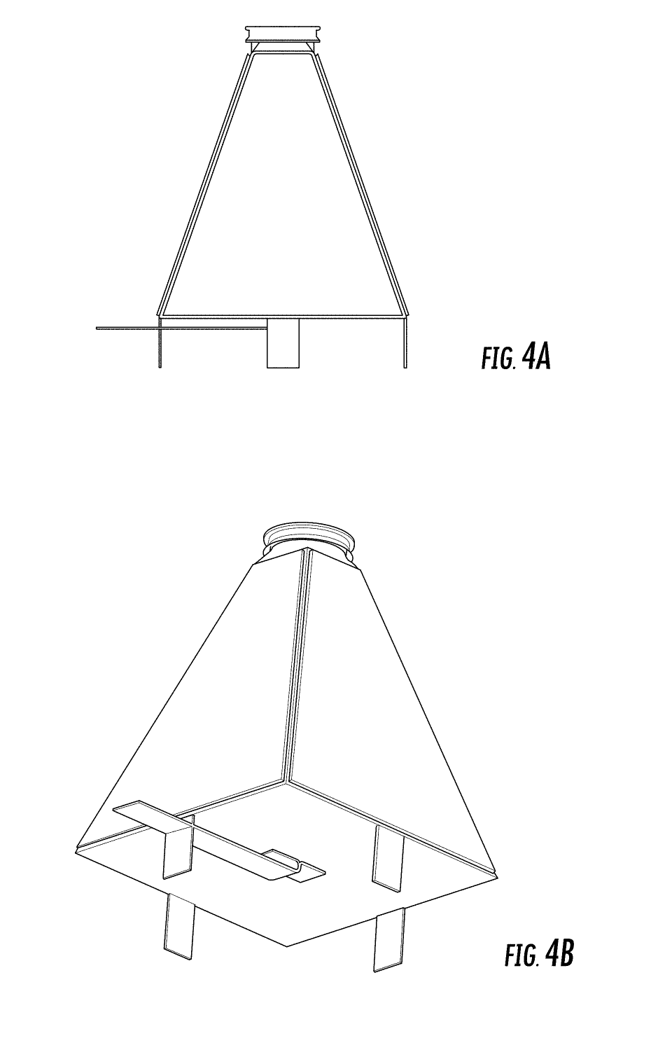

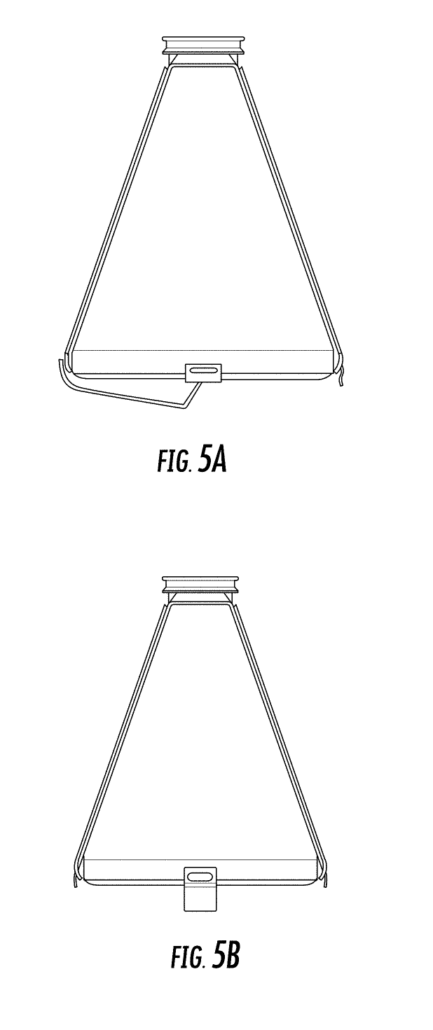

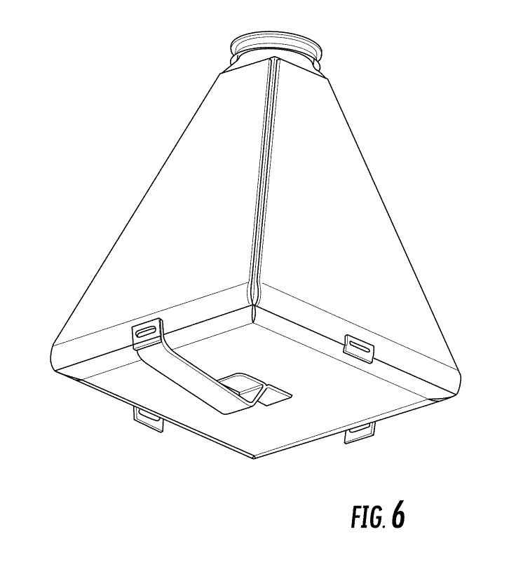

An embodiment example of a frame 10 according to the present disclosure is shown in FIGS. 1 to 3. The flexible package is shown in two embodiment variants, however any one of the figures shows just one variant, in FIGS. 4 to 6 separately without a frame.

The present disclosure is based on the concept of using such a flexible package 20 as a mixing container of a validated mixing process. Since the flexible package 20 cannot stand on its own, not even after filling, in this rigid form, the present disclosure proposes to design engagement locations or surfaces on the flexile package in such a way that it can at least partially be spread out. Insofar, the illustrations might create the impression to a viewer that the package stands unaided in this form. This is however not the case.

According to the present disclosure, to this end the flexible package 20 is clamped into a frame 10.

At least some sections of the wall, preferably however the complete wall in a laterally circulating manner and the bottom 24, are spread out in such a way that according to the views, the flexible package 20 adopts planar wall areas. To this end, various flaps may be provided at the bottom, see FIG. 8, although for the sake of clarity FIG. 8 only shows a single one. Preferably, flaps are fixed to the bottom lateral edges so as to be suspended therefrom, which flaps have for example a central hole provided therein. These flaps shown suspended may be hooked onto struts of the frame (not shown).

Apart from these connections, which do not allow any material to permeate into the inside of the package, for spreading out at least some sections of the wall so as to correspond to a pre-defined form, the package 20 has at least one docking connection for filling and discharging. To this end, a coupling element 22 is shown that in a simple form may simply be a ring. However, such an opening may be provided not only at the top but also at the bottom. It must be possible to vent the package in a controlled manner in order to achieve its desired form. To this end, the package preferably has a valve opening or a pressurized gas connection. Thus, for example, means for metering inert gas is provided. After discharging, the flexible packages according to the present disclosure have to be discarded. In order to provide improved controllability of such waste, a controlled evacuation through the above-mentioned openings can be achieved.

In order to improve explosion security, according to the present disclosure both the package and the frame are equipped with grounding lugs.

The shown embodiment example of the package according to the present disclosure has a square bottom 24 and, adjacent to the sides thereof, triangular stubs as lateral walls 26. Together, they form an upwardly open pyramid shape. The present disclosure also includes other shapes, such as spheres or octahedrons, which may be at least partially approximated with respect to their basic shapes by spreading out according to the present disclosure at least partial surfaces of the package.

Opposite the bottom 24, the flexible package presents, according to the illustrations, a coupling element 22 in a manner so as to seal the flexible package 20 in a standardized manner connected to its opening-sided ends 28 of the lateral walls 26.

According to preferred embodiments of the package 20, for an outward spreading out of partial surfaces, pockets 25 are provided as longitudinal guides which follow the connection lines between the lateral walls 26, into which pockets rods of the frame may be inserted, preferably when lowering the package into the frame 10. The rods (not shown) are preferably supported in a manner as to be rotatable at the bottom about a strut of the frame. At the top, they have free ends after the opening up, which are latched into the coupling element.

However, the frame can also be forced into a certain shape by just using clamping surfaces of the frame.

Accordingly, the present disclosure allows the handling of bulk goods without any further filling into standardized steel containers. The present disclosure mentions by way of example the mixing of bulk goods in a flexible package, which flexible package is spread out in a frame so as to forcibly assume, at least almost, a predefined body shape. The frame is then moved into the mixer in a manner in which otherwise the known rigid mixing containers would have to be clamped.

Advantageous methods according to the present disclosure ensure a clinging on or otherwise spreading out of the lateral walls and/or the bottom of the flexible package to form flat partial surfaces.

This specification has been written with reference to various non-limiting and non-exhaustive embodiments or examples. However, it will be recognized by persons having ordinary skill in the art that various substitutions, modifications, or combinations of any of the disclosed embodiments or examples (or portions thereof) may be made within the scope of this specification. Thus, it is contemplated and understood that this specification supports additional embodiments or examples not expressly set forth in this specification. Such embodiments or examples may be obtained, for example, by combining, modifying, or reorganizing any of the disclosed steps, components, elements, features, aspects, characteristics, limitations, and the like, of the various non-limiting and non-exhaustive embodiments or examples described in this specification. In this manner, Applicant reserves the right to amend the claims during prosecution to add features as variously described in this specification.

What is claimed:

1. Use of a flexible package (20) as a mixing container of a validated mixing method.

2. The use as claimed in claim 1, characterized in that, to this end, the flexible package (20) is clamped into a frame (10).

3. The use as claimed in claim 1, characterized in that at least some sections of the wall, however preferably in a laterally circulating manner the complete wall and the bottom, are spread out in such a way that planar wall surfaces or wall surfaces with known curves are adopted by the flexible package (20).

4. A flexible package (20) storing and transporting bulk goods, characterized in that it has material-impermeable connections for spreading out sections of the wall so as to correspond to a predefined shape and at least one docking connection for filling and discharging.

5. The flexible package (20) as claimed in claim 4, characterized in that it has a rectangular, in particular square bottom (24) and adjacent to the sides thereof triangular stubs as lateral walls (26), so that they form together an upwardly open pyramid shape, and that opposite the bottom (24), a coupling element (22) is connected in such a manner that it presents the flexible package (20) so as to be sealable in a standardized manner on open-sided ends (28) of the lateral walls (26).

6. The flexible package (20) as claimed in claim 4, characterized in that outside of the package (20) ready for spreading out, pockets (25) are provided as longitudinal guides, which pockets follow the connection lines between the lateral walls (26).

7. A frame for adopting a flexible package (20) as claimed in claim 4, characterized in that by means of the frame, the flexible package (20) is forced into a certain shape, at least on the periphery of partial surfaces of a desired body shape.

8. A method for treating bulk goods, comprising:
mixing the bulk goods in a flexible package, wherein the flexible package is spread out in a frame so as to forcibly adopt, at least almost, a predefined body shape.

9. A method according to claim 8, characterized in that the lateral walls and/or a bottom of the flexible package are tensioned to form planar partial surfaces and/or are caused to intimately rest against fixed walls.
